(19) United States
(12) Patent Application Publication
(10) Pub. No.: US 2024/0306147 A1
(43) Pub. Date: Sep. 12, 2024

(54) METHOD, DEVICE AND COMPUTER STORAGE MEDIUM OF COMMUNICATION

(71) Applicant: NEC Corporation, Tokyo (JP)

(72) Inventors: Da WANG, Beijing (CN); Gang WANG, Beijing (CN)

(73) Assignee: NEC Corporation, Tokyo (JP)

(21) Appl. No.: 18/279,558

(22) PCT Filed: Mar. 31, 2021
(86) PCT No.: PCT/CN2021/084693

§ 371 Date: Aug. 30, 2023

(51) Int. Cl. H04W 72/1268; H04W 72/21

(52) U.S. Cl. CPC H04W 72/1268; H04W 72/21

(57) ABSTRACT

Embodiments of the present disclosure relate to methods, devices and computer readable media for communication. The method comprises if first uplink data from at least one radio bearer not supporting a transmission in an inactive state arrives during a transmission of second uplink data in the inactive state, a terminal device generates an indication indicating the arriving of the first uplink data and transmits the indication to a network device. In this way, the transmission in the inactive state can be ensured to be finished in an efficiency way.

### TECHNICAL FIELD

Embodiments of the present disclosure generally relate to the field of telecommunication, and in particular, to methods, devices and computer storage media of communication during data transmission in an inactive state of a terminal device.

### BACKGROUND

Typically, a terminal device in an inactive state may still have small and infrequent data traffic to be transmitted. Until the third generation partnership project (3GPP) Release 16, the inactive state cannot support data transmission, and the terminal device has to resume connection (i.e., enter a connected state) for any downlink and uplink data. This will result in unnecessary power consumption and signaling overhead.

In this event, 3GPP Release 17 has approved small data transmission (SDT) in the inactive state. Thereby, the signaling overhead can be reduced. However, up to now, SDT-related techniques are still incomplete and to be further developed.

### SUMMARY

In general, embodiments of the present disclosure provide methods, devices and computer storage media for communication.

In a first aspect, there is provided a method of communication. The method comprises: in accordance with a determination that first uplink data from at least one radio bearer not supporting a transmission in an inactive state arrives during a transmission of second uplink data in the inactive state, generating, at a terminal device, an indication indicating the arriving of the first uplink data; and transmitting the indication to a network device.

In a second aspect, there is provided a method of communication. The method comprises: in accordance with a determination that uplink data is to be transmitted in an inactive state, determining, at a terminal device, whether an uplink grant from a network device accommodates the uplink data and does not additionally accommodate a buffer status report (BSR); and in accordance with a determination that the uplink grant accommodates the uplink data and does not additionally accommodate the BSR, cancelling the BSR.

In a third aspect, there is provided a method of communication. The method comprises: transmitting, at a terminal device, uplink data in an inactive state to a network device, wherein a power headroom report (PHR) is not triggered during the transmission of the uplink data in the inactive state.

In a fourth aspect, there is provided a method of communication. The method comprises: transmitting, at a terminal device, uplink data in an inactive state to a network device; and triggering a PHR.

In a fifth aspect, there is provided a method of communication. The method comprises: determining, at a terminal device and during a transmission of uplink data in an inactive state to a network device, whether reference signal receiving power (RSRP) of a serving cell of the terminal device is lower than a threshold power; and in accordance with a determination that the RSRP of the serving cell of the terminal device is lower than the is threshold power, entering an idle state; or terminating the transmission of the uplink data in the inactive state while remaining at the inactive state.

In a sixth aspect, there is provided a method of communication. The method comprises: receiving, at a network device and from a terminal device, an indication indicating that first uplink data from at least one radio bearer not supporting a transmission in an inactive state arrives during a transmission of second uplink data in the inactive state.

In a seventh aspect, there is provided a terminal device. The terminal device comprises a processor and a memory coupled to the processor. The memory stores instructions that when executed by the processor, cause the terminal device to perform the method according to any of the first to fifth aspects of the present disclosure.

In an eighth aspect, there is provided a network device. The network device comprises a processor and a memory coupled to the processor. The memory stores instructions that when executed by the processor, cause the network device to perform the method according to the sixth aspect of the present disclosure.

In a ninth aspect, there is provided a computer readable medium having instructions stored thereon. The instructions, when executed on at least one processor, cause the at least one processor to perform the method according to any of the first to fifth aspects of the present disclosure.

In a tenth aspect, there is provided a computer readable medium having instructions stored thereon. The instructions, when executed on at least one processor, cause the at least one processor to perform the method according to the sixth aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1A illustrates an example communication network in which some embodiments of the present disclosure can be implemented;

FIG. 1B illustrates a schematic diagram of a user plane (UP) protocol stack in which some embodiments of the present disclosure can be implemented;

FIG. 1C illustrates a schematic diagram of a control plane (CP) protocol stack in which some embodiments of the present disclosure can be implemented;

FIG. 2A illustrates a schematic diagram illustrating a SDT procedure in which some embodiments of the present disclosure can be implemented;

FIG. 2B illustrates a schematic diagram illustrating a SDT procedure comprising initial transmission and subsequent transmission in which some embodiments of the present disclosure can be implemented;

FIG. 3 illustrates a schematic diagram illustrating a process for communication during a SDT procedure according to embodiments of the present disclosure;

FIG. 4 illustrates an example method of communication implemented at a terminal device in accordance with some embodiments of the present disclosure;

FIG. 5 illustrates another example method of communication implemented at a terminal device in accordance with some embodiments of the present disclosure;

FIG. 6 illustrates another example method of communication implemented at a terminal device in accordance with some embodiments of the present disclosure;

FIG. 7 illustrates another example method of communication implemented at a terminal device in accordance with some embodiments of the present disclosure;

FIG. 8 illustrates another example method of communication implemented at a terminal device in accordance with some embodiments of the present disclosure;

FIG. 9 illustrates an example method of communication implemented at a network device in accordance with some embodiments of the present disclosure; and

FIG. 10 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. The term “terminal device” can be used interchangeably with a UE, a mobile station, a subscriber station, a mobile terminal, a user terminal or a wireless device. In addition, the term “network device” refers to a device which is capable of providing or hosting a cell or coverage where terminal devices can communicate. Examples of a network device include, but not limited to, a Node B (NodeB or NB), an Evolved NodeB (eNodeB or eNB), a next generation NodeB (gNB), a Transmission Reception Point (TRP), a Remote Radio Unit (RRU), a radio head (RH), a remote radio head (RRH), a low power node such as a femto node, a pico node, and the like.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to is the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

Currently, there are various applications that involve exchange of small and infrequency data. For example, in some applications of mobile devices, SDT may involve traffic from Instant Messaging (IM) services, heart-beat or keep-alive traffic, for example, from IM or email clients and other services, push notifications in various applications, traffic from wearables (including, for example, periodic positioning information), and/or the like. In some applications of non-mobile devices, SDT may involve sensor data (e.g., temperature, pressure readings transmitted periodically or in an event-triggered manner in an IoT network), metering and alerting information sent from smart meters, and/or the like.

During a SDT, uplink data from at least one of radio bearers supporting transmission in inactive state is transmitted in an inactive state of a terminal device. Whether one radio bearer supporting data transmission in inactive state is configured by the network device. In some scenarios, there may be new data (for convenience, also referred to as non-SDT data herein) arriving from radio bearers not supporting transmission in inactive state during the SDT.

In some scenarios, if an uplink grant from a network device can accommodate all pending data, a BSR may be cancelled or may be not cancelled. In case that the BSR is not cancelled, transmission of a BSR during the SDT will bring an adverse impact as the uplink data is not able to be finished within one transmission. In case that the BSR is not cancelled, if the BSR consider radio bearers not supporting data transmission in inactive state, the network device will provide UL grant to the terminal device, however the terminal device can't schedule the suspended radio bearers which results in resource waste.

In some other scenarios, a PHR is triggered upon configuration or reconfiguration of the power headroom reporting functionality by upper layers, which is not used to disable the functionality. In other words, the PHR will be triggered upon SDT Further, a PHR media access control control element (MAC CE) has a higher priority than data from any logical channel except data from uplink-common control channel (UL-CCCH).

For the above or other potential scenarios, embodiments of the present disclosure provide improved solutions of communication during a SDT, in order to make sure that the SDT can be finished as soon as possible. Principles and implementations of the present disclosure will be described in detail below with reference to the figures.

### Example of Communication Environment

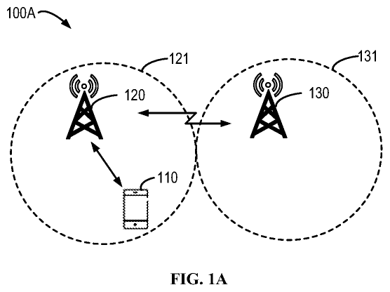

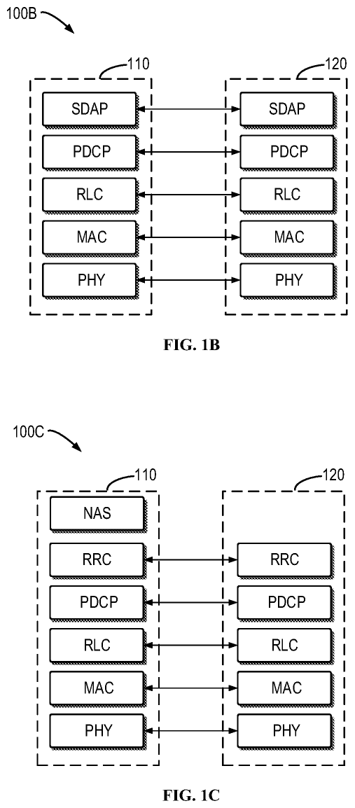

FIG. 1A illustrates a schematic diagram of an example communication network 100 in which some embodiments of the present disclosure can be implemented. As shown in FIG. 1A, the communication network 100 may include a terminal device 110 and a plurality of network devices 120 and 130. The network devices 120 and 130 provide respective cells 121 and 131 to serve a terminal device. In the example of FIG. 1A, the terminal device 130 is located within the cell 121 of the network device 120, and the terminal device 130 may communicate with the network device 120. The cell 121 may be referred to as a serving cell of the terminal device 130.

It is to be understood that the number of devices in FIG. 1A is given for the purpose of illustration without suggesting any limitations to the present disclosure. The communication network 100 may include any suitable number of network devices and/or terminal devices adapted for implementing implementations of the present disclosure. Further, each of the network devices 120 and 130 may provide more cells for the terminal device 110.

As shown in FIG. 1A, the terminal device 110 may communicate with the network device 120 via a channel such as a wireless communication channel. The communications in the communication network 100 may conform to any suitable standards including, but not limited to, Global System for Mobile Communications (GSM), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

In some scenarios of dual connection, the network device 120 and 130 may serve the terminal device 110 simultaneously as a master node (MN) or a secondary node (SN). The cells provided by the MN form a master cell group (MCG) for the terminal device 110, and the cells provided by the SN form a secondary cell group (SCG) for the terminal device 110. In some scenarios, the terminal device 110 may communicate with the network device 120 or 130 in an inactive state.

Communication in a direction from the terminal device 110 towards the network device 120 or 130 is referred to as UL communication, while communication in a reverse direction from the network device 120 or 130 towards the terminal device 110 is referred to as DL communication. The terminal device 110 can move amongst the cells of the network devices 120, 130 and possibly other network devices. In UL communication, the terminal device 110 may transmit UL data and control information to the network device 120 or 130 via a UL channel. In DL communication, the network device 120 or 130 may transmit DL data and control information to the terminal device 110 via a DL channel.

The communications in the communication network 100 can be performed in accordance with UP and CP protocol stacks. Generally speaking, for a communication device (such as a terminal device or a network device), there are a plurality of entities for a plurality of network protocol layers in a protocol stack, which can be configured to implement corresponding processing on data or signaling transmitted from the communication device and received by the communication device. FIG. 1B illustrates a schematic diagram 100B illustrating network protocol layer entities that may be established is for UP protocol stack at devices according to some embodiments of the present disclosure.

As shown in FIG. 1B, in the UP, each of the terminal device 110 and the network device 120 may comprise an entity for the L1 layer, i.e., an entity for a physical (PHY) layer (also referred to as a PHY entity), and one or more entities for upper layers (L2 and L3 layers, or upper layers) including an entity for a media access control (MAC) layer (also referred to as a MAC entity), an entity for a radio link control (RLC) layer (also referred to as a RLC entity), an entity for a packet data convergence protocol (PDCP) layer (also referred to as a PDCP entity), and an entity for a service data application protocol (SDAP) layer (also referred to as a SDAP entity, which is established in 5G and higher-generation networks). In some cases, the PHY, MAC, RLC, PDCP, SDAP entities are in a stack structure.

FIG. 1C illustrates a schematic diagram 100C illustrating network protocol layer entities that may be established for CP protocol stack at devices according to some embodiments of the present disclosure. As shown in FIG. 1C, in the CP, each of the terminal device 110 and the network device 120 may comprise an entity for the L1 layer, i.e., an entity for a PHY layer (also referred to as a PHY entity), and one or more entities for upper layers (L2 and L3 layers) including an entity for a MAC layer (also referred to as a MAC entity), an entity for a RLC layer (also referred to as a RLC entity), an entity for a PDCP layer (also referred to as a PDCP entity), and an entity for a radio resource control (RRC) layer (also referred to as a RRC entity). The RRC layer may be also referred to as an access stratum (AS) layer, and thus the RRC entity may be also referred to as an AS entity. As shown in FIG. 1C, the terminal device 110 may also comprise an entity for a non-access stratum (NAS) layer (also referred to as a NAS entity). An NAS layer at the network side is not located in a network device and is located in a core network (CN, not shown). In some cases, these entities are in a stack structure.

Generally, communication channels are classified into logical channels, transmission channels and physical channels. The physical channels are channels that the PHY layer actually transmits information. For example, the physical channels may comprise a physical uplink control channel (PUCCH), a physical uplink shared channel (PUSCH), a physical random-access channel (PRACH), a physical downlink control channel (PDCCH), a physical downlink shared channel (PDSCH) and a physical broadcast channel (PBCH).

The transmission channels are channels between the PHY layer and the MAC layer. For example, transmission channels may comprise a broadcast channel (BCH), a downlink shared channel (DL-SCH), a paging channel (PCH), an uplink shared channel (UL-SCH) and an random access channel (RACH).

The logical channels are channels between the MAC layer and the RLC layer. For example, the logical channels may comprise a dedicated control channel (DCCH), a common control channel (CCCH), a paging control channel (PCCH), broadcast control channel (BCCH) and dedicated traffic channel (DTCH).

Generally, channels between the RRC layer and PDCP layer are called as radio bearers. The terminal device 110 may be configured with at least one data radio bearer (DRB) for bearing data plane data and at least one signaling radio bearer (SRB) for bearing control plane data. In the context of the present disclosure, a DRB may be configured as supporting transmission in inactive state (i.e. supporting SDT). Of course, a DRB may also be configured as not supporting transmission in inactive state (i.e. supporting SDT). A SRB may be configured as supporting SDT. Of course, a SRB may also be configured as not supporting SDT.

Three types of SRBs are defined in a RRC layer, i.e., SRB0, SRB1 and SRB2. SRB0 uses a CCCH for RRC connection establishment, resume or reestablishment. SRB1 uses a DCCH and is established when RRC connection is established. SRB2 uses a DCCH and is established during RRC reconfiguration and after initial security activation.

In addition, a protocol data unit (PDU) session may be established at the NAS layer of the terminal device 110 to transmit data to CN or receive data from CN. A PDU session may correspond to a SDAP entity, and may comprise a plurality of quality of service (QoS) flows. In the context of the present disclosure, a QoS flow may be configured as supporting SDT. Of course, a QoS flow may also be configured as not supporting SDT.

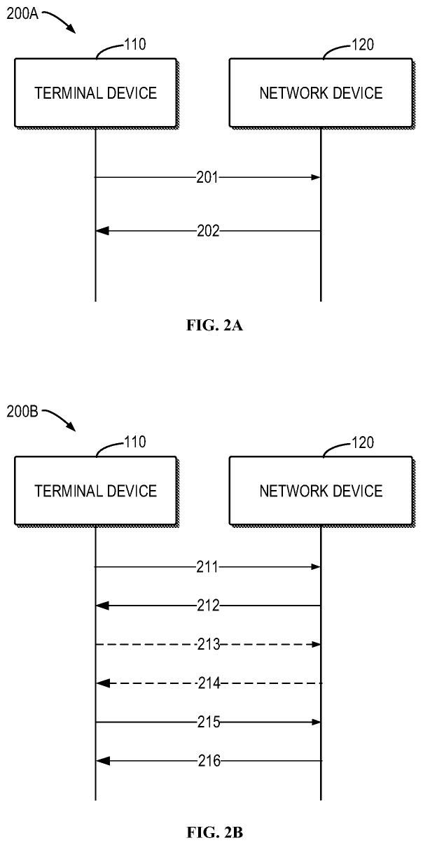

In the context of the present disclosure, the terminal device 110 may communicate with the network device 120 in an inactive state. In some scenarios, when the terminal device 110 has small and infrequency data traffic from radio bearer supporting SDT to be transmitted, the terminal device 110 may initiate a SDT procedure. FIG. 2A illustrates a schematic diagram illustrating a SDT procedure 200A for one-shot in which some embodiments of the present disclosure can be implemented. As shown in FIG. 2A, the terminal device 110 in an inactive state may transmit 201, to the network device 120, a RRC resume request with UL data associated with the data traffic. For example, the terminal device 110 may transmit the RRC resume request with UL data in Msg A of a 2-step RACH procedure or in Msg3 of a 4-step RACH procedure. Of course, the terminal device 110 may also transmit the RRC resume request with UL data in a configured grant (CG) resource. The RRC resume request may comprise a resume cause. Upon receipt of the RRC resume request and the UL data, the network device 120 may transmit 202 a RRC release message with DL data corresponding to the UL data to the terminal device 110. For example, the network device 120 may transmit the RRC release message with the DL data in Msg B of a 2-step RACH procedure or in Msg4 of a 4-step RACH procedure. Or the network device 120 may transmit the RRC release message with DL data as response of the transmission at the CG resource. So far, the SDT procedure 200A ends.

FIG. 2B illustrates a schematic diagram illustrating a SDT procedure 200B comprising initial transmission and subsequent transmission in which some embodiments of the present disclosure can be implemented. As shown in FIG. 2B, the terminal device 110 in an inactive state may transmit 211, to the network device 120, a RRC resume request with UL data and a BSR. For example, the terminal device 110 may transmit the RRC resume request with the UL data and the BSR in Msg A of a 2-step RACH procedure or in Msg3 of a 4-step RACH procedure. Of course, the terminal device 110 may also transmit the RRC resume request with UL data in a configured grant (CG) resource. The RRC resume request may comprise a resume cause. Upon receipt of the RRC resume request with the UL data and the BSR, the network device 120 may transmit 212 an indication of subsequent transmission to the terminal device 110. For example, the network device 120 may transmit an explicit RRC message indicating the subsequent transmission. As another example, the network device 120 may transmit an UL grant for further transmission so as to implicitly indicating the subsequent transmission. In some embodiments, the network device 120 may transmit DL data with the indication to the terminal device 110. So far, the initial transmission is done.

Based on the indication, the terminal device 110 may transmit 213 further UL data and BSR to the network device 120, for example, based on a dynamic grant or configured grant. Then the network device 120 may transmit 214 an UL grant for dynamic grant to the terminal device 110. In some embodiments, the network device 120 may transmit DL data with the UL grant to the terminal device 110. Based on the UL grant from the network device 120, the terminal device 110 may transmit 215 remaining UL data to the network device 120. Accordingly, the network device 120 may transmit 216 RRC release message to the terminal device 110. So far, subsequent transmission is done. That is, the SDT is procedure 200B ends. It is to be understood that the SDT procedure 200B may comprise more or less steps in the subsequent transmission.

### Example Implementation of Handling Non-SDT Data

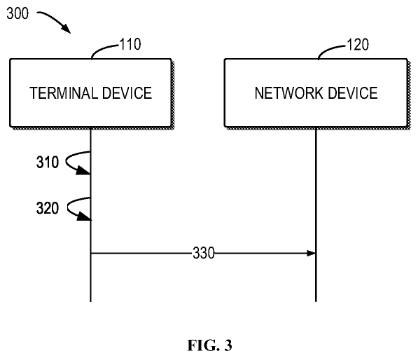

In some scenarios, uplink data from radio bearers not supporting SDT (i.e., non-SDT data) may arrive during a SDT procedure. In view of this, embodiments of the present application provide solutions for indicating the arriving of the non-SDT data. It will be described below with reference to FIG. 3. FIG. 3 illustrates a schematic diagram illustrating a process 300 for communication during a SDT procedure according to embodiments of the present disclosure. For the purpose of discussion, the process 300 will be described with reference to FIG. 1. The process 300 may involve the terminal device 110 and the network device 120 as illustrated in FIG. 1.

As shown in FIG. 3, the terminal device 110 determines 310 whether first uplink data from at least one radio bearer not supporting a transmission in an inactive state arrives during a transmission of second uplink data in the inactive state. In other words, the terminal device 110 determines whether non-SDT data arrives during a SDT procedure.

In some embodiments, if the first uplink data arrives, a NAS layer of the terminal device 110 may inform an AS layer of the terminal device 110 that the first uplink data arrives.

Traditionally, the NAS layer indicates the AS layer to resume RRC connection upon an uplink user data packet to be sent for a PDU session with suspended user-plane resources. However, if the new non-SDT data arriving during SDT is from the same PDU session, it is not clear if there is an indication from NAS layer to the AS layer to indicate the arriving of non-SDT data.

As a measure for this situation, when configuring the supporting of SDT for the radio bearers by a further network device and the terminal device 110 is in a connected state with the further network device, the further network device may configure all radio bearers having the same PDU session ID with the same configuration on whether to support SDT. In this case, the terminal device 110 may receive, from the further network device, a first configuration indicating that all DRBs associated with the same identity of a PDU session support a transmission in the inactive state, or a second configuration indicating that all the DRBs associated with the same identity of the PDU session do not support a transmission in the inactive state. In this way, the radio bearers not supporting a transmission in an inactive state will be in a PDU session different from the radio bearers supporting a transmission in an inactive state, and thus the NAS layer can inform the AS layer of the arriving of the non-SDT data in a traditional manner, i.e. by request the AS layer to transition to RRC Connected state. It is to be noted that the further network device may be the network device 120 or last serving network device or any other suitable network devices.

As another measure for the above situation, in some embodiments, the terminal device 110 may inform, from the AS layer to the NAS layer of the terminal device 110, the transmission of the second uplink data being performed in the inactive state, and also inform information on an ID of a QoS flow. In some embodiments, the information on the QoS flow ID may be IDs of QoS flows not supporting SDT. In some embodiments, the information on the QoS flow ID may be IDs of QoS flows supporting SDT. As the NAS layer know all the QoS flow IDs, the NAS layer can derive IDs of QoS flows not supporting SDT from the IDs of QoS flows supporting SDT. That is, the NAS layer can know that the terminal device 110 is performing SDT and know or derive the ID of the QoS flow not supporting SDT.

If the first uplink data is associated with the identity of the QoS flow not supporting SDT, the terminal device 110 may inform, from the NAS layer to the AS layer that the first uplink data arrives during the transmission of the second uplink data in the inactive state. In this way, when a new data arrives at the NAS layer, the NAS layer can know if the new data is non-SDT data from a QoS flow ID associated with the new data. As a result, the NAS layer can indicate the arriving of non-SDT data to the AS layer, e.g. by request the AS layer to transition to RRC_CONNECTED state.

If the first uplink data arrives, the AS layer of the terminal device 110 generates 320 an indication indicating the arriving of the first uplink data. In some embodiments, the terminal device 110 may determine whether an access attempt of the first uplink data is barred, and if the access attempt is not barred, the terminal device may generate the indication. That is, the terminal device 110 may perform a unified access control (UAC) procedure before generating the indication. The indication is generated only if the access attempt is not bared. In this way, communication efficiency can be improved.

Upon generation of the indication, the terminal device 110 transmits 330 the indication to the network device 120. The indication can be generated and transmitted in various ways. Some example embodiments for generating and transmitting the indication will be described below in connection with Embodiments 1 to 4.

### Embodiment 1

In this embodiment, the terminal device 110 may generate and transmit a DCCH message as the indication. For example, the terminal device 110 may generate a RRC message using SRB1 to indicate the arriving of data from at least one radio bearer not supporting SDT. In some examples, the RRC message may be an existing RRC message such as UEAssistanceInformation message. In some other examples, the RRC message may be a new RRC message dedicatedly introduced for the indication.

In some embodiments, the DCCH message may comprise a resume cause. In some embodiments, the DCCH message may comprise an expected RRC state, such as RRC CONNECTED state or any other suitable RRC states. In some embodiments, the DCCH message may comprise information of the first uplink data, i.e., information of the non-SDT data. For example, the information of the first uplink data may comprise at least one of the following: a size of the first uplink data, an identity (ID) of the at least one radio bearer, or a type of the at least one radio bearer. For example, the type of the at least one radio bearer may be MN terminated or SN terminated, MCG bearer or SCG bearer or split bearer.

In some embodiments, the DCCH message may comprise an expected measurement gap for a target band, for example, measurement gap requirement information of the terminal device 110 for NR target bands. In some embodiments, the DCCH message may comprise information of a mobility state of the terminal device 110. In some embodiments, the DCCH message may comprise an indication of availability of a measurement report in an idle or inactive state. In some embodiments, the DCCH message may comprise an indication of availability of at least one of logged measurements, connection establish failure information or radio link failure information. In some embodiments, the DCCH message may comprise an indication of availability of mobility history of the terminal device 110.

In some embodiments, the terminal device 110 may start or restart a timer (for convenience, also referred to as a first timer herein) before initiating the transmission of the DCCH message. For example, the terminal device 110 may reuse an existing timer such as T319. Of course, a new timer may also be introduced.

In some embodiments, the terminal device 110 may stop the first timer upon receipt of a response to the DCCH message from the network device 120. For example, the response to the DCCH message may be a RRCResume message, a RRCSetup message, a RRCRelease message, a RRCRelease message with suspendConfig or a RRCReject message. Of course, any other suitable messages are also feasible as the response to the DCCH message.

In some embodiments, the terminal device 110 may stop the first timer upon a cell reselection of the terminal device 110. In some embodiments, the terminal device 110 may stop the first timer upon an abortion of connection establishment associated with the first uplink data by upper layers.

In some embodiments, the terminal device 110 may store connection resume failure information upon expiry of the first timer and enter an idle state. For example, the terminal device 110 may perform the actions upon going to a RRC IDLE state with a release cause “RRC Resume failure”.

In some embodiments where the DCCH message is to be transmitted, the terminal device 110 may determine whether the first timer is running. If the first timer is not running, the terminal device 110 may transmit the DCCH message to the network device 120. In other words, the terminal device 110 is not allowed to send another DCCH message which indicates arriving of another non-SDT data while the first timer is running. In this way, the SDT procedure can be ensured to be done in an efficient way.

In some embodiments, the terminal device 110 may generate a BSR upon the generation of the DCCH message. That is, the arriving of the DCCH message can trigger the BSR. In some embodiments, if no uplink grant is available to transmit the BSR, the terminal device 110 may trigger a scheduling request (SR) to the network device 120. In some alternative embodiments, if no uplink grant is available to transmit the BSR, the terminal device 110 may initiate an random access procedure towards the network device 120.

In some embodiments, the terminal device 110 may receive a RRC release message (such as RRCRelease message) for the SDT from the network device 120. In this case, if the DCCH message has been generated by the RRC layer of the terminal device 110 or the first timer is running (i.e., there is non-SDT data arriving before RRCRelease message is received), the terminal device 110 will takes very long time to recover the transmission as the NAS layer of the terminal device 110 is not aware of such situation.

As a measure for this situation, in some embodiments, the terminal device 110 may initiate a RRC connection resume or setup procedure by the AS layer. In some alternative embodiments, the terminal device 110 may inform, from the AS layer to the NAS layer of the terminal device 110, a failure of a resume of a RRC connection for the first uplink data. As a result, the NAS layer can indicate the AS layer to resume or establish RRC connection. In this way, communication efficiency can be enhanced.

### Embodiment 2

In this embodiment, the terminal device 110 may generate and transmit a MAC CE as the indication. In some embodiments, the MAC CE may have a size of zero bits. That is, the MAC CE may have no content. In some alternative embodiments, the MAC CE may comprise information of the first uplink data. For example, the information of the first uplink data may comprise at least one of the following: a size of the first uplink data, an identity of the at least one radio bearer, or a type of the at least one radio bearer. For example, the type of the at least one radio bearer may be MN terminated or SN terminated, MCG bearer or SCG bearer or split bearer.

In some embodiments, the terminal device 110 may start or restart a timer (for convenience, also referred to as a second timer herein) before initiating the transmission of the MAC CE. For example, the terminal device 110 may reuse an existing timer such as T319. Of course, a new timer may also be introduced.

In some embodiments, the terminal device 110 may stop the second timer upon receipt of a response to the MAC CE from the network device 120. For example, the response to the MAC CE may be a RRCResume message, a RRCSetup message, a RRCRelease message, a RRCRelease message with suspendConfig or a RRCReject message. Of course, any other suitable messages are also feasible as the response to the MAC CE.

In some embodiments, the terminal device 110 may stop the second timer upon a cell reselection of the terminal device 110. In some embodiments, the terminal device 110 may stop the second timer upon an abortion of connection establishment associated with the first uplink data by upper layers.

In some embodiments, the terminal device 110 may store connection resume failure information upon expiry of the second timer and enter an idle state. For example, the terminal device 110 may perform the actions upon going to a RRC IDLE state with a release cause “RRC Resume failure”.

In some embodiments where the MAC CE is to be transmitted, the terminal device 110 may determine whether the second timer is running. If the second timer is not running, the terminal device 110 may transmit the MAC CE to the network device 120. In other words, the terminal device 110 is not allowed to send another MAC CE which indicates arriving of another non-SDT data while the second timer is running. In this way, the SDT procedure can be ensured to be done in an efficient way.

In some embodiments, if no uplink grant is available to transmit the MAC CE, the terminal device 110 may trigger a scheduling request (SR) to the network device 120. In some alternative embodiments, if no uplink grant is available to transmit the MAC CE, the terminal device 110 may initiate an random access procedure towards the network device 120.

In some embodiments, the terminal device 110 may receive a RRC release message (such as RRCRelease message) for the SDT from the network device 120. In this case, if the MAC CE has been generated by the RRC layer of the terminal device 110 or the second timer is running (i.e., there is non-SDT data arriving before RRCRelease message is received), the terminal device 110 will takes very long time to recover the transmission as the NAS layer of the terminal device 110 is not aware of such situation.

As a measure for this situation, in some embodiments, the terminal device 110 may initiate a RRC connection resume or setup procedure by the AS layer. In some alternative embodiments, the terminal device 110 may inform, from the AS layer to the NAS layer of the terminal device 110, a failure of a resume of a RRC connection for the first uplink data. As a result, the NAS layer can indicate the AS layer to resume or establish RRC connection. In this way, communication efficiency can be enhanced.

In some embodiments, the terminal device 110 may transmit the MAC CE in a priority higher than that for a MAC CE for a BSR (with exception of BSR included for padding) and lower than that for a MAC CE indicating a cell-radio network temporary identifier (C-RNTI) or that for data from an UL-CCCH. In some alternative embodiments, the terminal device may transmit the MAC CE in a priority higher than that for a MAC CE for a BSR (with exception of BSR included for padding). In some alternative embodiments, the terminal device may transmit the MAC CE in a priority lower than that for a MAC CE indicating a cell-radio network temporary identifier (C-RNTI) or that for data from an UL-CCCH. In this way, the SDT procedure can be ensured to be finished as soon as possible. For example, logical channels may be prioritized in accordance with the following order (highest priority listed first):
C-RNTI MAC CE or data from UL-CCCH;
MAC CE for indication of new arriving of non-SDT data;
Configured Grant Confirmation MAC CE or BFR MAC CE or Multiple Entry Configured Grant Confirmation MAC CE;
Sidelink Configured Grant Confirmation MAC CE;
LBT failure MAC CE;
MAC CE for SL-BSR prioritized;
MAC CE for BSR, with exception of BSR included for padding;
Single Entry PHR MAC CE or Multiple Entry PHR MAC CE;
MAC CE for the number of Desired Guard Symbols;
MAC CE for Pre-emptive BSR;
MAC CE for SL-BSR, with exception of SL-BSR prioritized according to clause 5.22.1.6 and SL-BSR included for padding;
data from any Logical Channel, except data from UL-CCCH.

### Embodiment 3

In this embodiment, the terminal device 110 may generate a message (such as a RRCResumeRequest message or RRCResumeRequest1 message) for requesting a RRC resume as the indication. That is, if there is arriving of non-SDT data after SDT is triggered, the RRC layer of the terminal device 110 may trigger another RRC resume procedure. The RRCResumeRequest message or RRCResumeRequest1 message during the RRC resume procedure becomes the indication for arriving of non-SDT data.

In some embodiments, the terminal device 110 may terminate the transmission of the second uplink data (i.e., SDT), and initiate the RRC resume procedure for transmission of the first uplink data. In some embodiments, the terminal device 110 may terminate the SDT by at least one of the following: discarding the current KgNB key, the KRRCenc key, the KRRCint key, the KUPint key and the KUPenc key; resetting a MAC entity of the terminal device 110 and releasing default MAC cell group configuration; reestablishing RLC entities of at least radio bearers supporting a transmission in the inactive state (i.e., all radio bearers or only radio bearers supporting a SDT); or suspending SRB1 and at least the radio bearers supporting a transmission in the inactive state (i.e. all radio bearers or only radio bearers supporting a transmission in the inactive state). It is to be understood that the termination of the SDT may comprise more or less actions than that listed above.

In some embodiments for the initiation of the RRC resume procedure, the terminal device 110 may provide a resume cause from the AS layer to the NAS layer. In some embodiments, the resume cause may be the same as that used in the previous SDT procedure. Of course, the resume cause may also adopt any other suitable ways. For example, the AS layer may provide the resume cause in RRCResumeRequest1 or RRCResumeRequest1 other than RNA purpose, e.g., when the NAS layer does not provide any new resume cause.

Considering a UAC procedure has been done before initiating the RRC resume procedure or before terminating the transmission of the second uplink data, in some embodiments, the terminal device 110 may skip the UAC procedure in the initiation of the RRC resume procedure for the first uplink data. In this way, communication efficiency can be improved.

### Embodiment 4

This embodiment is a combination of Embodiments 1 to 3. In this embodiment, if an uplink grant is available to transmit the indication, the terminal device 110 may generate and transmit the indication as described in Embodiment 1 or 2, i.e., by generating and transmitting the DCCH message or MAC CE.

If no uplink grant is available to transmit the indication, the terminal device 110 may generate and transmit the indication as described in Embodiment 3, i.e., by initiating another RRC Resume procedure. In this way, communication efficiency can be significantly improved.

Upon receipt of the indication, the network device 120 may transmit, to a further network device as a last serving network device of the terminal device 110, a request for retrieving context of the terminal device 110 with a further indication of arriving of non-SDT data.

### Example Implementation of Transmission of BSR During SDT

Traditionally, BSR may be cancelled or may be not cancelled if an uplink grant can accommodate all pending data. In case that the BSR is not cancelled, transmission of a BSR indicating empty during a SDT will bring an adverse impact. In view of this, embodiments of the present disclosure propose that the BSR for SDT is or should be or will be cancelled.

In some embodiments, if an uplink grant from the network device 120 accommodates the uplink data and does not additionally accommodate a BSR, the terminal device 110 may cancel the BSR. In this way, the SDT can be ensured to be finished as soon as possible.

In some embodiments, if the uplink grant from the network device 120 accommodates the uplink data and additionally accommodate the BSR, the terminal device 110 may generate the BSR without considering at least one radio bearer which is suspended. In other words, a data volume associated with the at least one radio bearer suspended is not counted in the generation of the BSR. In this way, data volume related to non-SDT data is excluded, and thus the SDT procedure can be performed in a more efficient way.

### Example Implementation of Transmission of PHR During SDT

Traditionally, a PHR is triggered upon configuration or reconfiguration of the power headroom reporting functionality by upper layers, which is not used to disable the functionality. In other words, the PHR will be triggered upon SDT. Further, a PHR MAC CE has a higher priority than data from any logical channel except data from UL-CCCH. In this case, if an uplink grant can only accommodate uplink data (including UL CCCH, DCCH and DTCH) but cannot accommodate the PHR MAC CE plus its header (three byte), the terminal device 110 has to perform subsequent transmission for SDT.

In view of this, embodiments of the present disclosure propose that the PHR is not transmitted if the uplink grant can accommodate all the pending data available for transmission but is not sufficient to additionally accommodate the PHR MAC CE plus its header. Some example embodiments will be described in connection with Embodiments 4 to 6.

### Embodiment 4

In this embodiment, the terminal device 110 may not trigger the PHR during a SDT procedure. For example, the PHR may not be triggered upon applying default MAC cell group configuration during SDT.

### Embodiment 5

In this embodiment, the terminal device 110 may trigger the PHR during a SDT procedure, but the MAC CE for PHR has lower priority than data of non-SDT DRBs and SRBs for SDT.

In some embodiments, if an uplink grant from the network device 120 accommodates the uplink data, the terminal device 110 may transmit the PHR in a priority lower than that for the uplink data. Otherwise, the terminal device 110 may transmit the PHR in a priority higher than that for the uplink data.

In some embodiments, if an uplink grant from the network device 120 accommodates the uplink data but does not additionally accommodate the PHR, the terminal device 110 may transmit the PHR in a priority lower than that for the uplink data. Otherwise, the terminal device 110 may transmit the PHR in a priority higher than that for the uplink data.

### Embodiment 6

In this embodiment, the terminal device 110 may cancel the PHR and start or restart a timer for triggering a generation of a further PHR. For example, the timer may be phr-PeriodicTimer or any other suitable timers.

In some embodiments, if an uplink grant from the network device 120 accommodates the uplink data, the terminal device 110 may cancel the PHR and start or restart the timer for triggering the generation of the further PHR.

In some alternative embodiments, if an uplink grant from the network device 120 accommodates the uplink data but does not additionally accommodate the PHR, the terminal device 110 may cancel the PHR and start or restart the timer for triggering the generation of the further PHR. In this way, the SDT procedure can be finished within one transmission.

### Example Implementation of Handling of RSRP Requirement During SDT

In some cases, one RSRP threshold may be used as one condition as whether to trigger SDT to make sure that the uplink data can be transmitted successfully as much as possible. Thereby, the terminal device 110 may check the RSRP of the camped cell or serving cell to see if it fulfills the RSRP threshold requirement. However, after SDT is triggered, and during the subsequent transmission phase, the RSRP threshold may be not fulfilled any more. Thus, the handling of the RSRP requirement during SDT should be studied.

According to embodiments of the present disclosure, the terminal device 110 may determine whether RSRP of a serving cell of the terminal device 110 is lower than a threshold power. In some embodiments, the terminal device 110 may determine whether the RSRP of the serving cell of the terminal device 110 is lower than the threshold power for a period of time.

In some embodiments, if the RSRP of the serving cell of the terminal device 110 is lower than the threshold power, the terminal device 110 may enter an idle state. For example, the terminal device 110 may perform the behavior upon going to RRC IDLE state with a release cause “RRC Resume failure”. It is to be noted that this merely is an example, and does not make limitation to the present disclosure.

In some embodiments, if the RSRP of the serving cell is lower than the threshold power, the terminal device 110 may terminate the transmission of the uplink data in the inactive state and remains at the inactive state. For example, the terminal device 110 may abort or terminate the current SDT procedure and remains at RRC INACTIVE state.

In some embodiments, the terminal device 110 may terminate the SDT by at least one of the following: discarding the current KgNB key, the KRRCenc key, the KRRCint key, the KUPint key and the KUPenc key; resetting a MAC entity of the terminal device 110 while releasing default MAC cell group configuration; reestablishing RLC entities of at least radio bearers supporting a transmission in the inactive state (i.e., all radio bearers or only radio bearers supporting a SDT); or suspending at least the radio bearers supporting a transmission in the inactive state (i.e., all radio bearers or only radio bearers supporting. It is to be understood that the termination of the SDT may comprise more or less actions than that listed above. In some embodiments, the terminal device 110 may trigger another RRC resume procedure for legacy data transmission if necessary.

### Example Implementation of Methods

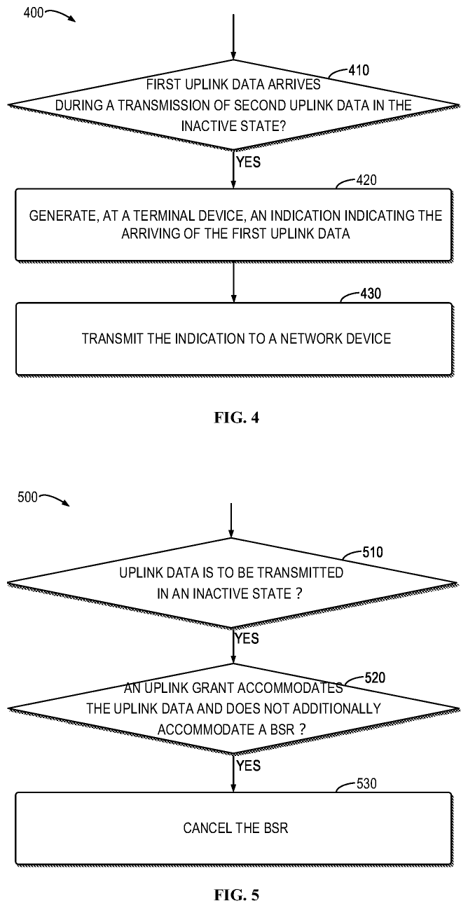

Accordingly, embodiments of the present disclosure provide methods of communication implemented at a terminal device and a network device. These methods will be described below with reference to FIGS. 4 to 9.

FIG. 4 illustrates an example method 400 of communication implemented at a terminal device in accordance with some embodiments of the present disclosure. For example, the method 400 may be performed at the terminal device 110 as shown in FIG. 1. For the purpose of discussion, in the following, the method 400 will be described with reference to FIG. 1. It is to be understood that the method 400 may include additional blocks not shown and/or may omit some blocks as shown, and the scope of the present disclosure is not limited in this regard.

At block 410, the terminal device 110 determines whether first uplink data from at least one radio bearer not supporting a transmission in an inactive state arrives during a transmission of second uplink data in the inactive state.

At block 420, if the first uplink data arrives, the terminal device 110 generates an indication indicating the arriving of the first uplink data. In some embodiments, the terminal device 110 may determine whether an access attempt of the first uplink data is barred, and if the access attempt is not barred, the terminal device 110 may generate the indication. At block 430, the terminal device 110 transmits the indication to the network device 120.

In some embodiments, the terminal device 110 may generate a DCCH message as the indication. In these embodiments, the terminal device 110 may transmit the DCCH message as the indication. In some embodiments, the DCCCH message may comprise at least one of the following: a resume cause, an expected RRC state, information of the first uplink data, an expected measurement gap for a target band, information of a mobility state of the terminal device 110, an indication of availability of a measurement report in an idle or inactive state, an indication of availability of at least one of logged measurements, connection establish failure information or radio link failure information, or an indication of availability of mobility history of the terminal device 110.

In some embodiments, the terminal device 110 may start or restarting a first timer before initiating the transmission of the DCCH message. In some embodiments, the terminal device 110 may stop the first timer upon at least one of the following: receipt of a response to the DCCH message from the network device, a cell reselection of the terminal device, or an abortion of connection establishment associated with the first uplink data.

In some embodiments, the terminal device 110 may store, upon expiry of the first timer, connection resume failure information; and entering an idle state. In some embodiments, the terminal device 110 may determine whether the first timer is running; and in accordance with a determination that the first timer is not running, the terminal device 110 may transmit the DCCH message to the network device 120.

In some embodiments, the terminal device 110 may generate a BSR upon the generation of the DCCH message, and if no uplink grant is available to transmit the BSR, the terminal device 110 may trigger a SR to the network device 120 or initiate an random access procedure towards the network device 120.

In some embodiments where the terminal device 110 receives a RRC release message from the network device 120, if the DCCH message has been generated or the first timer is running, the terminal device 110 may initiate a RRC connection resume or setup procedure by an AS layer of the terminal device 110 or inform, from the AS layer to a NAS layer of the terminal device 110, a failure of a RRC connection for the first uplink data.

In some embodiments, the terminal device 110 may generate a MAC CE as the indication, the MAC CE having a size of zero bits. In some embodiments, the terminal device 110 may generate a MAC CE as the indication, the MAC CE comprising information of the first uplink data. In these embodiments, the terminal device 110 may transmit the MAC CE as the indication.

In some embodiments, the information of the first uplink data may comprise at least one of the following: a size of the first uplink data, an identity of the at least one radio bearer, or a type of the at least one radio bearer.

In some embodiments, the terminal device 110 may start or restart a second timer before initiating the transmission of the MAC CE.

In some embodiments, the terminal device 110 may stop the second timer upon at least one of the following: receipt of a response to the MAC CE from the network device 120, a cell reselection of the terminal device 110, or an abortion of connection establishment associated with the first uplink data.

In some embodiments, the terminal device 110 may store connection resume failure information upon expiry of the second timer and enter an idle state.

In some embodiments, the terminal device 110 may determine whether the second timer is running, and if the second timer is not running, the terminal device 110 may transmit the MAC CE to the network device 120.

In some embodiments, the terminal device 110 may receive, from the network device 120, a RRC release message for the transmission of the second uplink data in the inactive state, and if the second timer is running, the terminal device 110 may initiate a RRC connection resume or setup procedure by an AS layer of the terminal device 110 or inform, from the AS layer to a NAS layer of the terminal device 110, a failure of a resume of a RRC connection for the first uplink data.

In some embodiments, if no uplink grant is available to transmit the MAC CE, the terminal device 110 may trigger a SR to the network device 120, or initiate an random access procedure towards the network device 120.

In some embodiments, the terminal device 110 may transmit the MAC CE in a priority higher than that for a MAC CE for a BSR with exception of BSR included for padding and lower than that for a MAC CE indicating a C-RNTI or that for data from an UL-CCCH.

In some embodiments, the terminal device 110 may terminate the transmission of the second uplink data, and initiating a RRC resume procedure for transmission of the first uplink data, wherein a message for requesting a RRC resume is generated during the RRC resume procedure as the indication.

In some embodiments, if an uplink grant is available to transmit the indication, the terminal device 110 may generate the indication. In these embodiments, if no uplink grant is available to transmit the indication, the terminal device 110 may terminate the transmission of the second uplink data and initiating a RRC resume procedure for transmission of the first uplink data, wherein a message for requesting a RRC resume is generated during the RRC resume procedure as the indication.

In some embodiments, the terminal device 110 may terminate the transmission of the second uplink data by at least one of the following: discarding the current KgNB key, the KRRCenc key, the KRRCint key, the KUPint key and the KUPenc key; resetting a MAC entity of the terminal device while releasing default MAC cell group configuration; reestablishing RLC entities of at least radio bearers supporting a transmission in the inactive state; or suspending SRB1 and at least the radio bearers supporting a transmission in the inactive state.

In some embodiments where the terminal device 110 initiates the RRC resume procedure, the terminal device 110 may provide, by an AS layer of the terminal device 110, a resume cause to a NAS layer of the terminal device 110. In some embodiments, the resume cause is the same as that used in the transmission of the second uplink data.

In some embodiments, the terminal device 110 may initiate the RRC resume procedure by skipping a determination that an access attempt of the first uplink data is allowed.

In some embodiments, the terminal device 110 may receive, from a further network device while the terminal device 110 is in a connected state with the further network device, a first configuration indicating that all DRBs associated with the same identity of a PDU session support a transmission in the inactive state, or a second configuration indicating that all the DRBs associated with the same identity of the PDU session do not support a transmission in the inactive state.

In some embodiments, the terminal device 110 may inform, from an AS layer to a NAS layer of the terminal device 110, the transmission of the second uplink data being performed in the inactive state and information on an identity of a QoS flow not supporting a transmission in an inactive state. If the first uplink data is associated with the identity of the QoS flow, the terminal device 110 may inform, from the NAS layer to the AS layer, that the first uplink data arrives during the transmission of the second uplink data in the inactive state.

In this way, the arriving of non-SDT data during the SDT can be indicated to the network side. The implementations of the method described in FIG. 4 substantially correspond to the process described in connection with FIG. 3, and thus other details are not repeated here.

FIG. 5 illustrates another example method 500 of communication implemented at a terminal device in accordance with some embodiments of the present disclosure. For example, the method 500 may be performed at the terminal device 110 as shown in FIG. 1. For the purpose of discussion, in the following, the method 500 will be described with reference to FIG. 1. It is to be understood that the method 500 may include additional blocks not shown and/or may omit some blocks as shown, and the scope of the present disclosure is not limited in this regard.

As shown in FIG. 5, at block 510, the terminal device 110 determines whether uplink data is to be transmitted in an inactive state. If the terminal device 110 determines that the uplink data is to be transmitted in the inactive state, the process proceeds to block 520.

At block 520, the terminal device 110 determines whether an uplink grant from the network device 120 accommodates the uplink data and does not additionally accommodate a BSR. If the terminal device 110 determines that the uplink grant accommodates the uplink data and does not additionally accommodate a BSR, the process proceeds to block 530. At block 530, the terminal device 110 cancels the BSR. In this way, the SDT can be ensured to be finished as soon as possible.

In some embodiments, if the uplink grant from the network device 120 accommodates the uplink data and additionally accommodate the BSR, the terminal device 110 may generate the BSR without considering at least one radio bearer suspended.

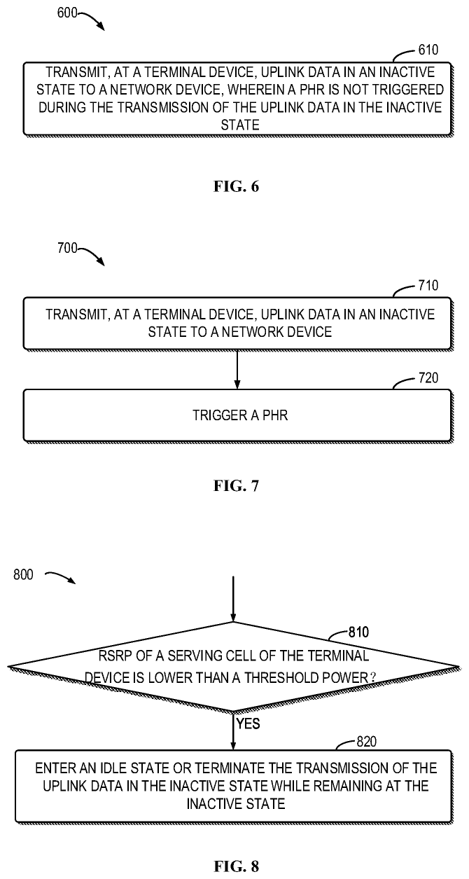

FIG. 6 illustrates another example method 600 of communication implemented at a terminal device in accordance with some embodiments of the present disclosure. For example, the method 600 may be performed at the terminal device 110 as shown in FIG. 1. For the purpose of discussion, in the following, the method 600 will be described with reference to FIG. 1. It is to be understood that the method 600 may include additional blocks not shown and/or may omit some blocks as shown, and the scope of the present disclosure is not limited in this regard.

As shown in FIG. 6, at block 610, the terminal device 110 transmits uplink data in an inactive state to a network device, wherein a PHR is not triggered during the transmission of the uplink data in the inactive state. In this way, the SDT also can be ensured to be finished as soon as possible.

FIG. 7 illustrates another example method 700 of communication implemented at a terminal device in accordance with some embodiments of the present disclosure. For example, the method 700 may be performed at the terminal device 110 as shown in FIG. 1. For the purpose of discussion, in the following, the method 700 will be described with reference to FIG. 1. It is to be understood that the method 700 may include additional blocks not shown and/or may omit some blocks as shown, and the scope of the present disclosure is not limited in this regard.

As shown in FIG. 7, at block 710, the terminal device 110 transmits uplink data in an inactive state to the network device 120. At block 720, the terminal device 110 triggers a PHR. In some embodiments, if an uplink grant from the network device 120 accommodates the uplink data, the terminal device 110 may transmit the PHR in a priority lower than that for the uplink data. In some embodiments, if an uplink grant from the network device 120 accommodates the uplink data and does not additionally accommodate the PHR, the terminal device 110 may transmit the PHR in a priority lower than that for the uplink data.

In some embodiments, if an uplink grant from the network device accommodates the uplink data, the terminal device 110 may cancel the PHR, and start or restart a timer for triggering a generation of a further PHR.

In some embodiments, if an uplink grant from the network device accommodates the uplink data and does not additionally accommodate the PHR, the terminal device 110 may cancel the PHR, and start or restart a timer for triggering a generation of a further PHR.

FIG. 8 illustrates another example method 800 of communication implemented at a terminal device in accordance with some embodiments of the present disclosure. For example, the method 800 may be performed at the terminal device 110 as shown in FIG. 1. For the purpose of discussion, in the following, the method 800 will be described with reference to FIG. 1. It is to be understood that the method 800 may include additional blocks not shown and/or may omit some blocks as shown, and the scope of the present disclosure is not limited in this regard.

As shown in FIG. 8, at block 810, the terminal device 110 determines whether RSRP of a serving cell of the terminal device 110 is lower than a threshold power during a transmission of uplink data in an inactive state. In some embodiments, the terminal device 110 may determine whether the RSRP is lower than the threshold power for a period of time.

If the RSRP of the serving cell of the terminal device is lower than the threshold power, the process proceeds to block 820. At block 820, the terminal device 110 enters an idle state or terminates the transmission of the uplink data in the inactive state while remaining at the inactive state.

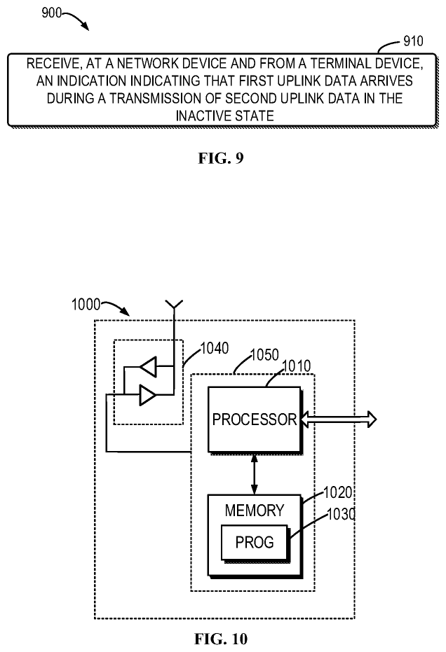

FIG. 9 illustrates an example method 900 of communication implemented at a network device in accordance with some embodiments of the present disclosure. For example, the method 900 may be performed at the network device 120 as shown in FIG. 1. For the purpose of discussion, in the following, the method 900 will be described with reference to FIG. 1. It is to be understood that the method 900 may include additional blocks not shown and/or may omit some blocks as shown, and the scope of the present disclosure is not limited in this regard.

As shown in FIG. 9, at block 910, the network device 120 receives, from the terminal device 110, an indication indicating that first uplink data from at least one radio bearer not supporting a transmission in an inactive state arrives during a transmission of second uplink data in the inactive state. In some embodiments, the network device 120 may receive a DCCH message as the indication. In some embodiments, the DCCH message may comprise at least one of the following: a resume cause, an expected RRC state, information of the first uplink data, an expected measurement gap for a target band, information of a mobility state of the terminal device 110, an indication of availability of a measurement report in an idle or inactive state, an indication of availability of at least one of logged measurements, connection establish failure information or radio link failure information, or an indication of availability of mobility history of the terminal device 110.

In some embodiments, the network device 120 may receive a SR from the terminal device. In some embodiments, the network device 120 may receive, from the terminal device 110, an random access request for performance of an random access procedure.

In some embodiments, the network device 120 may receive a MAC CE, the MAC CE having a size of zero bits. In some embodiments, the network device 120 may receive a MAC CE, the MAC CE comprising information of the first uplink data. In some embodiments, the information of the first uplink data may comprise at least one of the following: a size of the first uplink data, an identity of the at least one radio bearer, or a type of the at least one radio bearer.

In some embodiments, the network device 120 may transmit, to a further network device as a last serving network device of the terminal device 110, a request for retrieving context of the terminal device 110 with a further indication for the arriving of the first uplink data.

In some embodiments, while the terminal device 110 is in a connected state with the network device 120, the network device 120 may transmit, to the terminal device 110, a first configuration indicating that all DRBs associated with the same identity of a PDU session support a transmission in the inactive state or a second configuration indicating that all the DRBs associated with the same identity of the PDU session do not support a transmission in the inactive state.

### Example Implementation of Device

FIG. 10 is a simplified block diagram of a device 1000 that is suitable for implementing embodiments of the present disclosure. The device 1000 can be considered as a further example implementation of the terminal device 110 or the network device 120 or 130 as shown in FIG. 1. Accordingly, the device 1000 can be implemented at or as at least a part of the terminal device 110 or the network device 120 or 130.

As shown, the device 1000 includes a processor 1010, a memory 1020 coupled to the processor 1010, a suitable transmitter (TX) and receiver (RX) 1040 coupled to the processor 1010, and a communication interface coupled to the TX/RX 1040. The memory 1010 stores at least a part of a program 1030. The TX/RX 1040 is for bidirectional communications. The TX/RX 1040 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1030 is assumed to include program instructions that, when executed by the associated processor 1010, enable the device 1000 to operate in accordance with the embodiments of the present disclosure, as discussed herein with reference to FIGS. 1 to 9. The embodiments herein may be implemented by computer software executable by the processor 1010 of the device 1000, or by hardware, or by a combination of software and hardware. The processor 1010 may be configured to implement various embodiments of the present disclosure. Furthermore, a combination of the processor 1010 and memory 1020 may form processing means 1050 adapted to implement various embodiments of the present disclosure.

The memory 1020 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1020 is shown in the device 1000, there may be several physically distinct memory modules in the device 1000. The processor 1010 may be of any type suitable to the local technical network, and may include one or more of general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

In some embodiments, a terminal device comprises circuitry configured to: in accordance with a determination that first uplink data from at least one radio bearer not supporting a transmission in an inactive state arrives during a transmission of second uplink data in the inactive state, generate, at a terminal device, an indication indicating the arriving of the first uplink data; and transmit the indication to a network device.

In some embodiments, the circuitry may be configured to generate the indication by determining whether an access attempt of the first uplink data is barred; and in accordance with a determination that the access attempt is not barred, generating the indication.

In some embodiments, the circuitry may be configured to generate the indication by generating a DCCH message as the indication, the DCCH message comprising at least one of the following: a resume cause, an expected radio resource control (RRC) state, information of the first uplink data, an expected measurement gap for a target band, information of a mobility state of the terminal device, an indication of availability of a measurement report in an idle or inactive state, an indication of availability of at least one of logged measurements, connection establish failure information or radio link failure information, or an indication of availability of mobility history of the terminal device.

In some embodiments, the circuitry may be configured to transmit the indication by transmitting the DCCH message. In some embodiments, the circuitry may be further configured to start or restart a first timer before initiating the transmission of the DCCH message.

In some embodiments, the circuitry may be further configured to stop the first timer upon at least one of the following: receipt of a response to the DCCH message from the network device, a cell reselection of the terminal device, or an abortion of connection establishment associated with the first uplink data.

In some embodiments, the circuitry may be further configured to store, upon expiry of the first timer, connection resume failure information; and enter an idle state.

In some embodiments, the circuitry may be configured to transmit the DCCH message by determining whether the first timer is running; and in accordance with a determination that the first timer is not running, transmitting the DCCH message to the network device.

In some embodiments, the circuitry may be further configured to generate a BSR upon the generation of the DCCH message; and in accordance with a determination that no uplink grant is available to transmit the BSR, trigger a SR to the network device or initiate an random access procedure towards the network device.

In some embodiments, the circuitry may be further configured to receive, from the network device, a RRC release message; and in accordance with a determination that the DCCH message has been generated or the first timer is running: initiating, by an access stratum layer of the terminal device, a RRC connection resume or setup procedure, or informing, from the access stratum layer to a non-access stratum layer of the terminal device, a failure of a resume of a RRC connection for the first uplink data.

In some embodiments, the circuitry may be configured to generate the indication by generating a MAC CE as the indication, the MAC CE having a size of zero bits. In some embodiments, the circuitry may be configured to generate the indication by generating a MAC CE as the indication, the MAC CE comprising information of the first uplink data. In some embodiments, the information of the first uplink data comprises at least one of the following: a size of the first uplink data, an identity of the at least one radio bearer, or a type of the at least one radio bearer.

In some embodiments, the circuitry may be configured to transmit the indication by transmitting the MAC CE. In some embodiments, the circuitry may be further configured to start or restart a second timer before initiating the transmission of the MAC CE.

In some embodiments, the circuitry may be further configured to stop the second timer upon at least one of the following: receipt of a response to the MAC CE from the network device, a cell reselection of the terminal device, or an abortion of connection establishment associated with the first uplink data.

In some embodiments, the circuitry may be further configured to store, upon expiry of the second timer, connection resume failure information; and enter an idle state.

In some embodiments, the circuitry may be configured to transmit the MAC CE by determining whether the second timer is running; and in accordance with a determination that the second timer is not running, transmitting the MAC CE to the network device.

In some embodiments, the circuitry may be further configured to receive, from the network device, a RRC release message for the transmission of the second uplink data in the inactive state; and in accordance with a determination that the second timer is running, initiating, by an access stratum layer of the terminal device, a RRC connection resume or setup procedure, or informing, from the access stratum layer to a non-access stratum layer of the terminal device, a failure of a resume of a RRC connection for the first uplink data.

In some embodiments, the circuitry may be further configured to: in accordance with a determination that no uplink grant is available to transmit the MAC CE, trigger a SR to the network device, or initiate an random access procedure towards the network device.

In some embodiments, the circuitry may be configured to transmit the indication by transmitting the MAC CE in a priority higher than that for a MAC CE for a BSR with exception of BSR included for padding and lower than that for a MAC CE indicating a C-RNTI or that for data from an UL-CCCH.

In some embodiments, the circuitry may be configured to generate the indication by terminating the transmission of the second uplink data; and initiating a RRC resume procedure for transmission of the first uplink data, wherein a message for requesting a RRC resume is generated during the RRC resume procedure as the indication.

In some embodiments, the circuitry may be configured to generate the indication by generating the indication in accordance with a determination that an uplink grant is available to transmit the indication, and in accordance with a determination that no uplink grant is available to transmit the indication, terminating the transmission of the second uplink data; and initiating a RRC resume procedure for transmission of the first uplink data, wherein a message for requesting a RRC resume is generated during the RRC resume procedure as the indication.

In some embodiments, the circuitry may be configured to terminate the transmission of the second uplink data by at least one of the following: discarding the current KgNB key, the KRRCenc key, the KRRCint key, the KUPint key and the KUPenc key; resetting a MAC entity of the terminal device while releasing default MAC cell group configuration; reestablishing RLC entities of at least radio bearers supporting a transmission in the inactive state; or suspending signaling radio bearer 1 and at least the radio bearers supporting a transmission in the inactive state.

In some embodiments, the circuitry may be configured to initiate the RRC resume procedure by providing, by an access stratum layer of the terminal device, a resume cause to anon-access stratum layer of the terminal device. In some embodiments, the resume cause is the same as that used in the transmission of the second uplink data. In some embodiments, the circuitry may be configured to initiate the RRC resume procedure by skipping a determination that an access attempt of the first uplink data is allowed.

In some embodiments, the circuitry may be further configured to receive, from a further network device while the terminal device is in a connected state with the further network device, a first configuration indicating that all data radio bearers associated with the same identity of a PDU session support a transmission in the inactive state; or receive, from the network device, a second configuration indicating that all the data radio bearers associated with the same identity of the PDU session do not support a transmission in the inactive state.

In some embodiments, the circuitry may be further configured to inform, from an AS layer to a NAS layer of the terminal device, the transmission of the second uplink data being performed in the inactive state and information on an identity of a QoS flow not supporting a transmission in an inactive state; and in accordance with a determination that the first uplink data is associated with the identity of the QoS flow, informing, from the NAS layer to the AS layer that the first uplink data arrives during the transmission of the second uplink data in the inactive state.

In some embodiments, a terminal device comprises circuitry configured to: in accordance with a determination that uplink data is to be transmitted in an inactive state, determine, at a terminal device, whether an uplink grant from a network device accommodates the uplink data and does not additionally accommodate a BSR; and in accordance with a determination that the uplink grant accommodates the uplink data and does not additionally accommodate the BSR, cancel the BSR. In some embodiments, the circuitry may be further configured to generate the BSR without considering at least one radio bearer which is suspended if the uplink grant from the network device 120 accommodates the uplink data and additionally accommodate the BSR.

In some embodiments, a terminal device comprises circuitry configured to: transmit, at a terminal device, uplink data in an inactive state to a network device, wherein a PHR is not triggered during the transmission of the uplink data in the inactive state.

In some embodiments, a terminal device comprises circuitry configured to: transmit, at a terminal device, uplink data in an inactive state to a network device; and trigger a PHR. In some embodiments, the circuitry may be configured to transmit the PHR in a priority lower than that for the uplink data in accordance with a determination that an uplink grant from the network device accommodates the uplink data. In some embodiments, the circuitry may be configured to transmit the PHR in a priority lower than that for the uplink data in accordance with a determination that an uplink grant from the network device accommodates the uplink data and does not additionally accommodate the PHR.

In some embodiments, the circuitry may be further configured to: in accordance with a determination that an uplink grant from the network device accommodates the uplink data, cancel the PHR; and start or restart a timer for triggering a generation of a further PHR.

In some embodiments, the circuitry may be further configured to: in accordance with a determination that an uplink grant from the network device accommodates the uplink data and does not additionally accommodate the PHR, cancel the PHR; and start or restart a timer for triggering a generation of a further PHR.

In some embodiments, a terminal device comprises circuitry configured to: determine, at a terminal device and during a transmission of uplink data in an inactive state to a network device, whether RSRP of a serving cell of the terminal device is lower than a threshold power; and in accordance with a determination that the RSRP of the serving cell of the terminal device is lower than the threshold power, enter an idle state or terminate the transmission of the uplink data in the inactive state while remaining at the inactive state.

In some embodiments, the circuitry may be further configured to determine whether the RSRP of the serving cell of the terminal device is lower than the threshold power by determining whether the RSRP of the serving cell of the terminal device is lower than the threshold power for a period of time.

In some embodiments, a network device comprises circuitry configured to: receive, at the network device and from a terminal device, an indication indicating that first uplink data from at least one radio bearer not supporting a transmission in an inactive state arrives during a transmission of second uplink data in the inactive state.

In some embodiments, the circuitry may be configured to receive the indication by receiving a DCCH message as the indication, the DCCH message comprising at least one of the following: a resume cause, an expected RRC state, information of the first uplink data, an expected measurement gap for a target band, information of a mobility state of the terminal device, an indication of availability of a measurement report in an idle or inactive state, an indication of availability of at least one of logged measurements, connection establish failure information or radio link failure information, or an indication of availability of mobility history of the terminal device.

In some embodiments, the circuitry may be further configured to receive a SR from the terminal device; or receive, from the terminal device, an random access request for performance of an random access procedure.

In some embodiments, the circuitry may be configured to receive the indication by receiving a MAC CE, the MAC CE having a size of zero bits. In some embodiments, the circuitry may be configured to receive the indication by receiving a media access control MAC CE, the MAC CE comprising information of the first uplink data.

In some embodiments, the information of the first uplink data comprises at least one of the following: a size of the first uplink data, an identity of the at least one radio bearer, or a type of the at least one radio bearer.

In some embodiments, the circuitry may be further configured to transmit, to a further network device as a last serving network device of the terminal device, a request for retrieving context of the terminal device with a further indication for the arriving of the first uplink data.

In some embodiments, the circuitry may be further configured to, while the terminal device is in a connected state with the network device, transmit, to the terminal device, a first configuration indicating that all data radio bearers associated with the same identity of a PDU session support a transmission in the inactive state; or transmit, to the terminal device, a second configuration indicating that all the data radio bearers associated with the same identity of the PDU session do not support a transmission in the inactive state.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 3 to 9. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1.-49. (canceled)

50. A method of a User Equipment (UE), the method comprising:
initiating a Small Data Transmission (SDT) procedure; and
transmitting, to a network, a Dedicated Control Channel (DCCH) message to inform about an arrival of data mapped to a radio bearer not configured for the SDT procedure, in a case where the data mapped to the radio bearer not configured for the SDT procedure becomes available during the SDT procedure.

51. The method according to claim 50,
wherein the DCCH message includes a Resume Cause.

52. The method according to claim 50,
wherein the DCCH message is a UE Assistance Information message.

53. The method according to claim 50, further comprising:
triggering a Power Headroom Report (PHR) procedure.

54. The method according to claim 53, further comprising:
cancelling the PHR procedure, in a case where the SDT procedure is ongoing and an Uplink (UL) grant can accommodate all pending data available for transmission but is not sufficient to additionally accommodate a PHR Medium Access Control (MAC) Control Element (CE) plus its header fields.

55. A method of a User Equipment (UE), the method comprising:
initiating a Small Data Transmission (SDT) procedure;
triggering a Power Headroom Report (PHR) procedure; and
cancelling the PHR procedure, in a case where the SDT procedure is ongoing and an Uplink (UL) grant can accommodate all pending data available for transmission but is not sufficient to additionally accommodate a PHR Medium Access Control (MAC) Control Element (CE) plus its header fields.

56. A User Equipment (UE) comprising:
a memory; and
a processor coupled to the memory, wherein the processor is configured to:
initiate a Small Data Transmission (SDT) procedure; and
transmit, to a network, a Dedicated Control Channel (DCCH) message to inform about an arrival of data mapped to a radio bearer not configured for the SDT procedure, in a case where the data mapped to the radio bearer not configured for the SDT procedure becomes available during the SDT procedure.

57. The UE according to claim 56,
wherein the DCCH message includes a Resume Cause.

58. The UE according to claim 56,
wherein the DCCH message is a UE Assistance Information message.

59. The UE according to claim 56,
wherein the processor is configured to:
trigger a Power Headroom Report (PHR) procedure.

60. The UE according to claim 59,
wherein the processor is configured to:
cancel the PHR procedure, in a case where the SDT procedure is ongoing and an Uplink (UL) grant can accommodate all pending data available for transmission but is not sufficient to additionally accommodate a PHR Medium Access Control (MAC) Control Element (CE) plus its header fields.

61. A User Equipment (UE) comprising:
a memory; and
a processor coupled to the memory, wherein the processor is configured to:
initiate a Small Data Transmission (SDT) procedure;
trigger a Power Headroom Report (PHR) procedure; and
cancel the PHR procedure, in a case where the SDT procedure is ongoing and an Uplink (UL) grant can accommodate all pending data available for transmission but is not sufficient to additionally accommodate a PHR Medium Access Control (MAC) Control Element (CE) plus its header fields.
